(19) United States
(12) Patent Application Publication
(10) Pub. No.: US 2011/0135936 A1
(43) Pub. Date: Jun. 9, 2011

(54) WATER-BASED PRIMER COMPOSITION AND COATING METHOD USING THE SAME

(76) Inventors: Hideaki Katsuta, Hiratsuka-shi (JP); Masaharu Ishiguro, Hiratsuka-shi (JP); Naoya Haruta, Hiratsuka-shi (JP); Takeshi Kishi, Miyoshi-shi (JP); Hisakazu Kotake, Miyoshi-shi (JP); Yoshizumi Matsuno, Kanuma-shi (JP)

(21) Appl. No.: 13/057,196

(22) PCT Filed: Aug. 6, 2009
(86) PCT No.: PCT/JP2009/064280

§ 371 Date: Feb. 2, 2011

(30) Foreign Application Priority Data
Aug. 8, 2008 (JP) 2008205379

(51) Int. Cl. H01B 1/24; B32B 27/40; B05D 1/36

(52) U.S. Cl. 428/423.1; 252/500; 252/511; 427/470; 977/742; 977/902

(57) ABSTRACT

This invention provides a water-based primer composition comprising an aqueous dispersion of modified polyolefin, aqueous urethane resin and/or aqueous acrylic resin, specific diester compound and electrically conducting pigment, the content of the diester compound being specific. The water-based primer composition excels in adhesive property to plastic substrates, and use of the water-based primer composition enables formation of multilayered coating film excelling in finished appearance and water resistance, being free of layer mixing even when the top coating of the next step is carried out after the primer's application without an intervening preheating.

### TECHNICAL FIELD

This invention relates to a water-based primer composition excelling in adhesive property to plastic substrate, which furthermore is capable of forming multilayered coating film excelling in finished appearance and water resistance, being free of layer mixing even when the top coating of the next step is carried out after the primer's application without an intervening preheating; and also to coating methods using said composition.

### BACKGROUND ART

Plastic shaped articles such as of polyolefines and the like have been widely used as members of outer panels of automobiles or household electric appliances, and these shaped articles are often advancedly coated with a primer containing chlorinated polyolefin or the like, for improving the adhesion between the top coating and the shaped articles. Because of the required solubility for chlorinated polyolefin, aromatic organic solvent including toluene and xylene has been used for this primer, but from the viewpoint of hygienic safety and environmental preservation, switching over to aqueous solvent is progressed in recent years.

Also because the shaped articles usually have a volume specific resistance of at least about 10¹⁰ Ω·cm, it is difficult to directly apply a top coating onto such plastic shaped articles by electrostatic coating method which excels in transfer efficiency. Hence, it is an ordinary practice to impart to the primer electric conductivity, and after its application a top coating for coloring is electrostatically applied (e.g., see JP 6-165966A, WO 2007/046532).

As the coating method, for example, JP 10-296171A or JP 2004-331911A proposed 3-coat-1-bake system including top coating application, in which coloring base coating and clear coating are successively applied after application of a water-based primer. When a water-based primer is used in such a wet-on-wet system, it is necessary to effect preheating after application of the water-based primer even for as short as a few minutes, before conducting the subsequent coating step, for securing good finished appearance after the top coating application.

In the actual coating line, however, omission of the preheating step is in demand for space and energy saving. An attempt to meet the demand by reducing thickness of the primer film to accelerate its drying gives rise to poor finished appearance due to defective film forming depending on the booth environments (in particular, under low humidity condition of not higher than RH65%), and there arises also a problem of faulty electric conduction. Furthermore, in case of multilayered coating film, omission of the preheating step is difficult in view of not only the finished appearance after the top coating application but also physical properties of the coating film such as water resistance.

### SUMMARY OF THE INVENTION

The object of the present invention is to provide a water-based primer composition which can form multilayered coating film excelling in finished appearance, water resistance and so on, even when the subsequent top coating application step is conducted after its application without an intervening preheating; and a coating method using the composition.

We have engaged in concentrative studies to now discover that the use of a water-based primer composition containing a specific amount of a specific diester compound accomplishes the above object, and come to complete the present invention.

Thus, the present invention provides a water-based primer composition characterized in that it comprises

(A) an aqueous dispersion of modified polyolefin,

(B) an aqueous urethane resin and/or aqueous acrylic resin,

(C) a diester compound of the general formula (1)

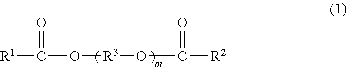

[in the formula, R¹ and R² each independently stands for C₄₋₁₈ hydrocarbon group, R³ stands for C₂₋₄ alkylene group, m is an integer of 3-20, and mR³s may be the same or different] and

(D) an electrically conducting pigment,

the content of the diester compound (C) being within a range of 1-15 mass parts to 100 mass parts of the total solid content of the component (A) and the component (B).

The invention also provides a coating method characterized by comprising applying the above water-based primer composition onto plastic substrate surface, and then applying a top coating onto the coated surface.

According to the present invention, use of the water-based primer composition containing the specific compound of the formula (1) makes it possible to form multilayered coating film excelling in finished appearance and water resistance, when the subsequent top coating application step is conducted after the primer application without an intervening preheating, even under unfavorable coating booth conditions such as low humidity.

### EMBODIMENTS FOR WORKING THE INVENTION

### Aqueous Dispersion (A) of Modified Polyolefin

The water-based primer composition according to the present invention comprises an aqueous dispersion (A) of modified polyolefin. The aqueous dispersion (A) of modified polyolefin is one formed by dispersing a polyolefin (i) which has been modified with unsaturated carboxylic acid or acid anhydride in an aqueous medium.

The unsaturated carboxylic acid- or acid anhydride-modified polyolefin (i) can be obtained by preparing a polyolefin by (co)polymerizing at least one kind of olefin selected from C₂₋₁₀, in particular, C₂₋₄, olefins such as ethylene, propylene, butylene, hexene and so on; and further modifying the polyolefin by graft polymerizing therewith a C₃₋₁₀, in particular, C₄₋₈, unsaturated carboxylic acid (preferably unsaturated mono- or di-caroxylic acid) such as (meth)acrylic acid, maleic acid, fumaric acid, itaconic acid and so on or an anhydride of such an unsaturated carboxylic acid. In particular, one modified with maleic acid or anhydride thereof is preferred. The amount of grafting with the unsaturated carboxylic acid or acid anhydride thereof is not strictly limited but can be varied according to, e.g., the properties desired for the coating film, while generally adequate range is, based on the mass of the polyolefin, 1-20 mass %, preferably 1.5-15 mass %, inter alia, 2-10 mass %.

As the polyolefin to be used to form the unsaturated carboxylic acid- or the acid anhydride-modified polyolefin (i), particularly those prepared with use of a single site catalyst as the polymerization catalyst are preferred, from the viewpoint of narrow molecular weight distribution of resulting polyolefin and also excellent random copolymerizability. Single site catalysts refers to those having same kind of active site (single site), among which metallocene catalysts are particularly preferred. Metallocene catalysts are prepared by combining metallocene [bis(cyclopentadienyl)metal complexes and derivatives thereof] which are the compounds normally having at least one conjugated five-membered ring ligand and containing Groups IV-VI or Group VIII transition metal compound or Group III rare earth transition metal of the periodic table; promoters capable or activating it such as aluminoxane and the like; and organoaluminum compounds such as trimethylaluminum.

The polyolefins can be prepared by any methods known per se, for example, by continuously adding alkylaluminum and a metallocene catalyst to a reactor into which an olefin such as propylene or ethylene and hydrogen are being supplied.

The unsaturated carboxylic acid- or acid anhydride-modified polyolefin (i) may further be acrylic modified, where necessary. Examples of polymerizable unsaturated monomer useful for the acrylic modification include alkyl esters of (meth)acrylic acid such as methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, lauryl (meth)acrylate and stearyl (meth)acrylate; acrylic monomers such as (meth)acrylic acid, glycidyl (meth)acrylate, 2-hydroxyethyl (meth)acrylate, (meth)acrylamide and (meth)acrylonitrile; and styrene. These can be used each alone or in combination of two or more.

In the present specification, “(meth)acrylic” means acrylic or methacrylic, and “(meth)acrylate” means acrylate or methacrylate.

As the means for acrylic modification, for example, a method comprising first reacting the unsaturated carboxylic acid- or acid anhydride-modified polyolefin with a monomer reactable with the carboxyl groups in the modified polyolefin, such as glycidyl (meth)acrylate, to introduce polymerizable unsaturated groups into the modified polyolefin; and then copolymerizing at least one other monomer with the modified polyolefin into which the polymerizable unsaturated groups have been introduced. Desirable use amount of the polymerizable unsaturated monomer for the acrylic modification, from the viewpoint of compatibility with other components and adhesive property of formed coating film, is not more than 30 mass %, in particular, within a range of 0.1-20 mass %, inter alia, 0.15-15 mass %, based on the solid mass of the resulting modified polyolefin (i).

Also from the viewpoint of water resistance, moisture resistance and gasohol resistance of the formed coating film, the unsaturated carboxylic acid- or acid anhydride-modified polyolefin (i) may be modified with a compound having polyoxyalkylene chain, where necessary. As the polyoxyalkylene chain in the polyoxyalkylene chain-containing compound, for example, polyoxyethylene chain, polyoxypropylene chain, blocked chain of polyoxyethylene and polyoxypropylene and the like can be named.

The polyoxyalkylene chain-containing compound preferably has a number-average molecular weight within a range of normally 400-3,000, in particular 500-2,000. Where the number-average molecular weight is less than 400, the compound cannot fully exhibit the effect of the hydrophilic groups and is liable to adversely affect the coating film performance (in particular, water resistance). Whereas, when it is more than 3,000, it solidifies at ambient temperature and its solubility is reduced to render its handling difficult.

The modification with such a polyoxyalkylene chain-containing compound can be effected by, for example, reaction of the unsaturated carboxylic acid- or acid anhydride-modified polyolefin with a compound (a) having hydroxyl group at one end and also a polyoxyalkylene chain, or where the unsaturated carboxylic acid- or acid anhydride-modified polyolefin has been acrylic modified as above, reaction of such a polyolefin with a compound (b) having a polymerizable unsaturated group at one end and also a polyoxyalkylene chain.

Examples of the compound (a) having hydroxyl group at one end and also a polyoxyalkylene chain include polyoxyalkylene alkyl ethers such as polyoxyethylene stearyl ether; polyoxyalkylene alkyl phenyl ethers such as polyoxyethylene nonyl phenyl ether and polyoxyethylene dodecyl phenyl ether; polyoxyalkyleneglycol fatty acid esters such as polyoxyethylene fatty acid ester; and polyoxyalkylene alkylamines such as polyoxyethylene alkylamine and ethylene oxide/propylene oxide polymer adduct of alkylalkanolamine. Those can be used either alone or in combination of two or more.

The reaction of the unsaturated carboxylic acid- or acid anhydride-modified polyolefin with the compound (a) having hydroxyl group at one end and also a polyoxyalkylene chain can be effected by, for example, heat-melting the unsaturated carboxylic acid- or acid anhydride-modified polyolefin at 80-200° C., adding thereto the compound (a), and heating after optionally adding a basic substance or the like. The use ratio of the compound (a) in that occasion is desirably within a range of normally 0.5-50 mass parts, in particular, 0.5-25 mass parts, per 100 mass parts of the solid content of the unsaturated carboxylic acid- or acid anhydride-modified polyolefin.

Examples of the compound (b) having a polymerizable unsaturated group at one end and also a polyoxyalkylene chain include polyethylene glycol (meth)acrylate, polypropylene glycol (meth) acrylate, polyoxyethylene methyl ether (meth)acrylate, polyoxypropylene methyl ether (meth)acrylate, polyoxyethylene lauryl ether (meth)acrylate, polyoxyethylene nonyl phenyl ether (meth)acrylate, polyoxyethylene lauryl ether maleic acid ester, allyl-containing polyoxyethylene nonyl phenyl ether and the like. Those may be used either alone or in combination of two or more.

The reaction between the unsaturated carboxylic acid- or acid anhydride-modified polyolefin with the compound (b) having a polymerizable unsaturated group on one end and also a polyoxyalkylene chain can be carried out by, for example, heat melting the unsaturated carboxylic acid- or acid anhydride-modified polyolefin at 80-200° C., adding thereto, similarly to the above-described acrylic modification, for example, glycidyl (meth)acrylate, 2-hydroxyethyl (meth)acrylate or the like which is reactable with the carboxyl groups in the unsaturated carboxylic acid- or acid anhydride-modified polyolefin, and if necessary further adding a polymerization inhibitor, basic substance or the like, heating the system to introduce into the modified polyolefin the polymerizable unsaturated group first, adding thereto the compound (b) and if necessary a polymerization initiator and the like, followed by heating. Desirable use ratio of the compound (b) is normally within a range of 0.5-50 mass parts, in particular, 0.5-25 mass parts, per 100 mass parts of the solid content of the unsaturated carboxylic acid- or acid anhydride-modified polyolefin.

The unsaturated carboxylic acid- or acid anhydride-modified polyolefin (i) may further be chlorinated, where necessary. Chlorination of the polyolefin can be effected by, for example, blowing chlorine gas into an organic solvent solution or dispersion of the polyolefin or a modification product thereof. The reaction temperature can be within a range of 50-120° C. The chlorine content in the chlorinated polyolefin (solid content) is variable according to physical property(ies) desired for the chlorinated polyolefin, while it is generally desirable to make it not higher than 35 mass %, in particular, within a range of 10-30 mass %, inter alia, 12-25 mass %, based on the mass of the chlorinated polyolefin, from the viewpoint of adhesive property of formed coating film.

As the polyolefins used in the unsaturated carboxylic acid- or acid anhydride-modified polyolefin (i), particularly those containing propylene as a polymerization unit are preferred. The mass proportion of propylene in the unsaturated carboxylic acid- or acid anhydride-modified polyolefin (i) is preferably within a range of normally 0.5-0.99, in particular, 0.6-0.97, inter alia, 0.7-0.95, from the viewpoint of compatibility with other components and adhesive property of formed coating film.

Thus obtained unsaturated carboxylic acid- or acid anhydride-modified polyolefin (i) can generally have a melting point not higher than 120° C., preferably within a range of 50-100° C., inter alia, 60-90° C.; and a mass-average molecular weight (Mw) within a range of generally 30,000-180,000, preferably 50,000-150,000, inter alia, 70,000-120,000. Where the melting point and mass-average molecular weight of the modified polyolefin deviate from above-specified ranges, the modified polyolefin's compatibility with other components, and interlayer adhesiveness of the coating film formed therefrom to the substrate or the top coating film layer undesirably decrease. In view of the adhesive property as above, the unsaturated carboxylic acid- or acid anhydride-modified polyolefin (i) preferably has a heat of fusion within a range of generally 1-50 mJ/mg, in particular, 2-50 mJ/mg.

Here the melting point and the heat of fusion are determined with use of a differential scanning calorimeter, DSC-5200 (tradename, Seiko Instruments & Electronics Ltd.) to measure the quantity of heat when 20 mg of the modified polyolefin is heated from −100° C. to 150° C., at a temperature rise rate of 10° C./min. Where it is difficult to determine the heat of fusion, the test sample may be heated up to 120° C., then cooled at a rate of 10° C./min., left standing for at least 2 days and then the quantity of heat is measured by the above method.

Adjustment of melting point of the modified polyolefin (i) can be effected by, for example, varying composition of the polyolefin, in particular, varying the amount of α-olefin monomer.

The mass-average molecular weight of the modified polyolefin (i) is its mass-average molecular weight measured with gel permeation chromatography as converted based on the mass-average molecular weight of polystyrene. The measurement is made with HLC/GPC 150C (tradename, Water Co., 60 cm×1) at the column temperature of 135° C., using as the solvent o-dichlorobenzene, at a flow rate of 1.0 ml/min. The injected sample is formulated by dissolving the modified polyolefin in o-dichlorobenzene by heating at 140° C. for 1-3 hours, to make the concentration of the solution 5 mg/3.4 ml. As the column used in the gel permeation chromatography, GMH_{HR}-H(S)HT (tradename, Tosoh Corporation) can be named.

It is furthermore desirable that the unsaturated carboxylic acid- or acid anhydride-modified polyolefin (i) has a ratio of the mass-average molecular weight to the number-average molecular weight (Mw/Mn) within a range of generally 1.5-4.0, in particular, 2.0-3.5, inter alia, 2.0-3.0, from the viewpoint of compatibility with other components and adhesive property of formed coating film.

The aqueous dispersion (A) of the modified polyolefin used in the present invention Can be obtained by dispersing the above unsaturated carboxylic acid- or acid anhydride-modified polyolefin (i) in an aqueous medium, for example, deionized water. In that occasion, a part or the whole of the carboxyl groups in the unsaturated carboxylic acid- or acid anhydride-modified polyolefin (i) may be neutralized with an amine compound and/or dispersed in water using an emulsifier, where necessary. When the modified polyolefin (i) has a polyoxyalkylene chain, it can be dispersed in an aqueous medium without the use of such an amine compound or emulsifier or using only minor amounts of them.

Examples of the amine compound include tertiary amines such as triethylamine, tributylamine, dimethylethanolamine and triethanolamine; secondary amines such as diethylamine, dibutylamine, diethanolamine and morpholine; and primary amines such as propylamine and ethanolamine.

When such an amine compound is used, its desirable use rate is normally within a range of 0.1-1.0 molar equivalent to the carboxyl groups in the unsaturated carboxylic acid- or acid anhydride-modified polyolefin (i).

Examples of the emulsifier include nonionic emulsifiers such as polyoxyethylene monooleyl ether, polyoxyethylene monostearyl ether, polyoxyethylene monolauryl ether, polyoxyethylene tridecyl ether, polyoxyethylene phenyl ether, polyoxyethylene nonyl phenyl ether, polyoxyethylene octyl phenyl ether, polyoxyethylene monolaurate, polyoxyethylene monostearate, polyoxyethylene monooleate, sorbitan monolaurate, sorbitan monostearate, sorbitan trioleate and polyoxyethylene sorbitan monolaurate; and anionic emulsifiers such as sodium salts or ammonium salts of alkylsulfonic acid, alkylbenzenesulfonic acid and alkylphosphoric acid. Furthermore, polyoxyalkylene group-containing anionic emulsifiers having an anionic group and polyoxyalkylene group such as polyoxyethylene group or polyoxypropylene group in one molecule, or reactive anionic emulsifiers having the anionic group and polymerizable unsaturated group in one molecule can also be used. These can be used either alone or in combination of two or more.

Desirable use rate of the emulsifier is normally not more than 30 mass parts, in particular, within a range of 0.5-25 mass parts, per 100 mass parts of the solid content of the unsaturated carboxylic acid- or acid anhydride-modified polyolefin (i).

### Aqueous Urethane Resin and/or Aqueous Acrylic Resin (B)

The water-based primer composition of the present invention contains an aqueous urethane resin (B-1) and/or an aqueous acrylic resin (B-2).

The aqueous urethane resin (B-1) is a water-soluble or water-dispersible resin having urethane linkages in its molecule, examples of which include self-emulsifying type emulsion having an acid value or an emulsion formed by concurrent use of an emulsifier, water-soluble resin, and the like. The form of a dispersion is particularly preferred. A urethane dispersion is normally obtained by advancedly reacting a diol with diisocyanate and, where necessary, dimethylolalkanoic acid or the like in the presence of an emulsifier and, while dispersing the resulting urethane prepolymer in water, subjecting the system to forced emulsification or self-emulsification.

The skeletal structure of the aqueous urethane rein (B-1) can be, for example, ether type, carbonate type, or ester type. Of these, ether type or carbonate type are preferred in respect of water resistance of formed coating film. The aqueous urethane resin (B-1) may also contain hydroxyl groups.

As the aqueous acrylic resin (B-2), water-soluble acrylic resins having a mass-average molecular weight within a range of normally 5,000-100,000, preferably 5,000-50,000, which are usually obtained through copolymerization of a monomer mixture comprising hydrophilic group-containing polymerizable unsaturated monomer(s) such as carboxyl-containing polymerizable unsaturated monomer and other polymerizable unsaturated monomer(s); or acrylic resin emulsions having a mass-average molecular weight of no less than 50,000, preferably no less than 100,000, can be used. The mass-average molecular weight is the value obtained by converting the mass-average molecular weight measured by gel permeation chromatography using tetrahydrofuran as the solvent, on the basis of the mass-average molecular weight of polystyrene. For the gel permeation chromatography, “HLC8120GPC” (tradename, Tosoh Corporation) can be used, and as the columns used in the gel permeation chromatography, four columns of “TSKgel G-4000 H×L”, “TSKgel G-3000H×L”, “TSKgel G-2500 H×L”, and “TSKgel G-2000 H×L” (tradenames, Tosoh Corporation) can be used.

Examples of the carboxyl-containing polymerizable unsaturated monomer include (meth)acrylic acid, crotonic acid, maleic acid, fumaric acid, itaconic acid, and half monoalkyl esterified products of the dicarboxylic acids named among the above exemplification. Also examples of the hydrophilic group-containing polymerizable unsaturated monomer other than the above include polyalkylene chain-containing polymerizable unsaturated monomers such as polyethylene glycol (meth)acrylate and polypropylene glycol (meth)acrylate; sulfonic acid group-containing polymerizable unsaturated monomers such as 2-acrylamide-2-methyl-propanesulfonic acid and sulfoalkyl (meth)acrylates such as 2-sulfoethyl (meth)acrylate; tertiary amino group-containing polymerizable unsaturated monomers such as N,N-dimethylaminoethyl (meth)acrylate and N,N-diethylaminoethyl (meth)acrylate; quaternary ammonium salt group-containing polymerizable unsaturated monomers such as 2-(methacryloyloxy)ethyltrimethylammonium chloride and 2-(methacryloyloxy)ethyltrimethylammonium bromide; and quaternarized ammonium carboxyl-containing polymerizable unsaturated monomers.

Examples of the other polymerizable unsaturated monomer include C₁₋₂₄ alkyl esters or cycloalkyl esters of acrylic acid or methacrylic acid such as methyl (meth)acrylate, ethyl (meth)acrylate, n- or i-propyl (meth)acrylate, n-, i-, or t-butyl (meth)acrylate, 2-ethylhexyl (meth)acrylate, cyclohexyl (meth)acrylate, lauryl (meth)acrylate and isobornyl (meth)acrylate; hydroxyalkyl esters of acrylic or methacrylic acid such as 2-hydroxyethyl (meth)acrylate, 2- or 3-hydroxypropyl (meth)acrylate and 4-hydroxybutyl (meth)acrylate; glycidyl (meth)acrylate, acrylonitrile, acrylamide, styrene, vinyltoluene, vinyl acetate, vinyl chloride, 1,6-hexanediol diacrylate and the like. These can be used either alone or in combination of two or more.

Copolymerization of above monomer mixture is subject to no particular limitation and can be carried out by any method known per se. For example, water-soluble acrylic resins can be formed by solution polymerization methods, and acrylic resin emulsions, by emulsion polymerization methods.

Where the aqueous acrylic resin (B-2) is an acrylic resin emulsion which is obtained particularly by emulsion polymerization, it may be a multilayer-structured particulate emulsion formed through multistage emulsion polymerization of the monomer mixture in the presence of water and an emulsifier.

The acidic groups such as carboxyl groups derived from the hydrophilic group-containing polymerizable unsaturated monomer(s) in the aqueous acrylic resin (B-2) may be neutralized with a basic substance, where necessary. The basic substances useful in such an occasion preferably are water-soluble, examples of which include ammonia, methylamine, ethylamine, propylamine, butylamine, dimethylamine, trimethylamine, triethylamine, ethylenediamine, morpholine, methylethanolamine, dimethylethanolamine, diethanolamine, triethanolamine, diisopropanolamine, and 2-amino-2-methylpropanol. These can be used either alone or in, combination of two or more.

It is desirable for the aqueous acrylic resin (B-2) to contain hydroxyl groups. From the viewpoint of water-dispesibility, compatibility with the other components, and curability of formed coating film, the resin preferably has a hydroxyl value within a range of generally 20-200 mgKOH/g, in particular, 20-150 mgKOH/g; and an acid value within a range of generally 1-100 mgKOH/g, in particular, 10-70 mgKOH/g.

According to the present invention, the use ratio of the aqueous dispersion (A) to the resin (B) preferably is within a range of generally 10/90-70/30, in particular, 15/85-65/35, inter alia, 20/80-60/40, in terms of the solid mass ratio of the component (A)/component (B). Outside the above-specified range is undesirable because it results in decrease in adhesive ability of formed coating film to the materials, water resistance, gasohol resistance and the like.

### Diester Compound (C)

The water-based primer composition of the present invention comprises a diester compound represented by the following general formula (1):

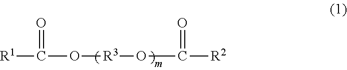

[in the formula, R¹ and R² each independently stands for C₄₋₁₈ hydrocarbon group, R³ stands for C₂₋₄ alkylene group, m is an integer of 3-20, and mR³s may be the same or different].
   Use of the diester compound enables the primer to excel in film-forming property and secure electrical conductivity even when its film thickness is thinned, and irrelevantly to the booth environments, multilayered coating film exhibiting excellent finished appearance and water resistance can be formed even when preheating after application of the primer is omitted and the subsequent top coating application step is carried out.

As the hydrocarbon group represented by R¹ or R² in the above formula (1), C₅₋₁₁ alkyl groups, in particular, C₅₋₉ alkyl groups, inter alia C₆₋₈ alkyl groups, are preferred. Particularly when the R¹ and R² are C₆₋₈ branched alkyl groups, excellent film-forming property can be imparted to the formed coating film, even where the primer composition is applied after a relatively long period of storage. Preferred R³ is ethylene, and particularly preferred in is an integer of 4-10.

The diester compound (C) can be obtained, for example, by esterification reaction of a polyoxyalkylene glycol having two terminal hydroxyl groups with a monocarboxylic and having a C₄₋₁₈ hydrocarbon group.

Examples of the polyoxyalkylene glycol include polyethylene glycol, polypropylene glycol, polyethylene glycol/polypropylene glycol block copolymer, and polybutylene glycol, among which the use of polyethylene glycol is particularly preferred. These polyoxyalkylene glycols preferably have a weight-average molecular weight within a range of generally about 120-about 800, in particular, about 150-about 600, inter alia, about 200-about 400, in respect of water resistance.

Examples of the monocarboxylic acid having a C₄₋₁₈ hydrocarbon group include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid and octadecanoic acid. Of these, monocarboxylic acid having C₅₋₉ alkyl groups such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid and 4-ethyloctanoic acid are preferred. In particular, monocarboxylic acids having C₆₋₈ alkyl groups such as heptanoic acid, 2-ethylpentanoic acid, 3-ethylpentanoic acid, octanoic acid, 2-ethylhexanoic acid, 4-ethylhexanoic acid, nonanoic acid and 2-ethylheptanoic acid are more favorable. The most favorable are those monocarboxylic acids having C₆₋₈ branched alkyl groups such as 2-ethylpentanoic acid, 3-ethylpentanoic acid, 2-ethylhexanoic acid, 4-ethylhexanoic acid and 2-ethylheptanoic acid.

The diesterification reaction of the polyoxyalkylene glycol with the monocarboxylic acid can be effected by a method known per se. The above polyoxyalkylene glycols and monocarboxylic acids can be used each either alone or in combination of two or more.

From the viewpoint of film-forming property, finished appearance and water resistance, the resulting diester compound (C) preferably has a molecular weight within a range of generally about 320-about 1,000, in particular, about 400-about 800, inter alia about 500-about 700.

The content of the diester compound (C) in the water-based primer composition of the present invention lies within a range of generally 1-15 mass parts, preferably 2-13.5 mass parts, inter alia, 3-12 mass parts, per 100 mass parts of the total solid content of the component (A) and component (B). Where the content of the diester compound (C) is less, deviating from the above-specified range, film-forming property of the composition drops to impair the finished appearance when the primer film thickness becomes thin. Where it is more, deviating from the above-specified range, water resistance or finished appearance of resulting multilayered coating film are undesirably impaired.

### Electrically Conducting Pigment (D)

The water-based primer composition of the present invention comprises electrically conducting pigment (D).

The electrically conducting pigment (D) is subject to no particular limitation, so long as it can impart conductivity to the formed coating film, and those in any forms such as particle, flake and fiber (including whisker) can be used. Specific examples include conducting carbons such as conducting carbon black, carbon nanotube, carbon nanofiber, and carbon microcoil; and metal powders such as of silver, nickel, copper, graphite and aluminum; antimony-doped tin oxide, phosphorus-doped tin oxide, acicular titanium oxide surface coated with tin oxide/antimony, antimony oxide, zinc antimonate, indium tin oxide, and pigments formed by surface-coating whiskers of carbon or graphite with tin oxide or the like; pigments formed by surface-coating mica flakes with at least one electrically conducting metal oxide selected from the group consisting of tin oxide, antimony-doped tin oxide, tin-doped indium oxide (ITO), fluorine-doped tin oxide (FTO), phosphorus-doped tin oxide and nickel oxide; and conducting pigment of titanium dioxide particles with tin oxide- and phosphorus-containing surface. These can be used either alone or in combination of two or more. Of these, electrically conducting carbon can be particularly conveniently used.

The content of the electrically conducting pigment (D) is, from the viewpoint of conductivity impartation, and adhesive property and water resistance of formed coating film, within a range of normally 1-300 mass parts, in particular, 3-250 mass parts, inter alia 5-180 mass parts, per 100 mass parts of the total solid content of the component (A) and component (B) of the water-based primer composition. Particularly when a conducting carbon is used, its desirable use rate is within a range of normally 1-30 mass parts, in particular, 3-25 mass parts, inter alia, 5-25 mass parts, per 100 mass parts of the total solid content of the component (A) and component (B) of the composition.

The water-based primer composition of the present invention can further contain, where necessary, pigment(s) other than above electrically conducting pigment, for example, coloring pigments such as titanium oxide, red iron oxide, aluminum paste, and azo- or phthalocyanine-type pigments; and extenders such as talc, silica, calcium carbonate, barium sulfate and zinc flower (zinc oxide). These can be used either alone or in combination of two or more.

### Water-Based Primer Composition:

The water-based primer composition of the present invention can be formulated, for example, by mixing the above-described aqueous dispersion (A) of modified polyolefin, resin (B), diester compound (C) and electrically conducting pigment (D) by an accepted means, and suitably diluting the mixture with an aqueous medium, for example, deionized water.

The water-based primer composition of the present invention may contain a crosslinking agent where necessary. As the crosslinking agent, normally amino resin and/or (blocked) polyisocyanate, which are reactable with the hydroxyl groups contained in the resin (B), and so on can be used. An epoxy compound reactable with the carboxyl groups in the aqueous dispersion (A) of modified polyolefin may also be used as the crosslinking agent.

The water-based primer composition of the present invention may further contain paint additives such as curing catalyst, thickener, defoamer, organic solvent, surface regulating agent and the like, where necessary.

Because the water-based primer composition of the present invention can reduce the water content of the coating film transferred onto the coated object, it is convenient to make its solid content at the application time normally no less than 30 wt %, in particular, within a range of 35-45 wt %.

The water-based primer composition of the present invention is, as aforesaid, applicable to plastic shaped articles. Examples of the plastic shaped articles include those used for outer panel parts of automobiles such as bumpers, spoilers, grills and fenders; and outer panel parts of household electric appliances. As the material therefor, polyolefins produced by (co)polymerization of one or more than one C₂₋₁₀ olefins such as ethylene, propylene, butylene, hexene and the like are particularly suitable. Besides, the water-based primer composition of this invention can also be applied to polycarbonate, ABS resin, urethane resin, polyamide and the like.

These plastic shaped articles can be suitably given degreasing treatment, washing with water or the like by the means known per se, in advance of their coating with the water-based primer composition of the present invention.

Application of the water-based primer composition of the present invention onto such a plastic shaped article is conveniently carried out by means of air spray, airless spray, dip coating or brushing, to form the coating having a dry film thickness within a range of normally 1-20 μm, preferably 2-10 μm, and for still further securing good film-forming property and accelerating the rise in the solid content of the transferred coating after the application, inter alia, 3-7 μm. After application of the composition, if necessary the resulting coated surface may be set at the room temperature for around 30 seconds-60 minutes, or preheated at a temperature of about 40-about 80° C. for around 1-60 minutes, or cured by heating at a temperature of about 60-about 140° C., preferably about 70-about 120° C., for around 20-40 minutes. According to the invention, in particular, it is possible to carry out the next step of a top coating application without preheating the as-coated water-based primer composition of the present invention. It is preferred to give a setting, after application of the water-based primer composition of the invention, at the room temperature (about 20-about 35° C.) for around 30 seconds-3 minutes. Whereby the solid content of the transferred coating after application of the water-based primer composition of the invention can be quickly raised (for example, it is preferable to raise the solid content of the transferred coating after 1 minute of the application to at least 50 mass %, preferably at least 60 mass %), and layer mixing with the upper layer coating film can be prevented without any preheating. Here the solid content of a transferred coating, for example, the solid content of a transferred coating after 1 minute of its application, can be determined as follows: first, apply a coating onto a fixed area of aluminum foil under the same conditions as described above, recover the foil after 1 minute of the application, immediately fold in the aluminum foil to prevent any further evaporation of water from the coated film and quickly measure its weight. Then open up the aluminum foil, cure the coated film thereon under the same conditions to those of heat-curing the multilayered coating film, measure the weight after the curing, and calculate the solid content of the transferred coating from these weights and the advancedly measured weight of the aluminum foil itself.

Thus formed primer coating film is electrically conducting. It is desirable for the cured coating film to have a surface resistivity of generally not higher than 1×10⁸Ω/□, in particular, not higher than 1×10⁷Ω/□, whereby the electrically conducting primer coating film enables satisfactory electrostatic coating in the next step. Here the measurement of “surface resistivity” is made with a coating film applied to a dry film thickness of about 15 μm, after drying at 80° C. for 10 minutes, using a surface ohmmeter manufactured by TREK Inc., of the tradename TREK MODEL 150 (unit: Ω/□).

The plastic shaped article coated with the water-based primer composition of the invention can then be electrostatically coated with a top coating. As the top coating, a coloring coating may be applied by itself, or the coloring coating may be used as a base coating, so that the base coating and a clear coating can be successively applied. It is also possible to form a multilayered film by applying as the coloring base coating layer, for example, a white base coating and a pearlescent base coating successively.

As the coloring coating, those known per se can be used, which usually comprise a coloring component such as coloring pigment, effect pigment, dye and the like and a resin component such as the base resin and crosslinking agent, and in which organic solvent and/or water serve as the main solvent.

Examples of the base resin used in the coloring coating include such resins as acrylic, polyester and alkyd resins having reactive functional groups such as hydroxyl, epoxy, carboxyl, silanol and the like; and examples of the crosslinking agent include amino resins such as melamine resin, urea resin and the like, (blocked) polyisocyanate, polyepoxide, polycarboxylic acid and the like.

The coloring coating can contain, where necessary, paint additives such as extender, curing catalyst, ultraviolet absorber, coated surface regulating agent, rheology controlling agent, antioxidant, defoaming agent, wax, antiseptic, and the like.

The color coating is electrostatically applied onto the above-described uncured or cured primer coating film, to a thickness of dried film within a range of normally 5-50 μm, preferably 5-30 μm, inter alia, 10-20 μm. The resulting coated surface can be set at the ambient temperature for around 1-60 minutes, or preheated at about 40-about 80° C. for around 1-60 minutes, where necessary; or can be cured by heating at about 60-about 140° C., preferably about 80-about 120° C. for around 20-40 minutes. According to the present invention, it is particularly convenient to successively apply a clear coating after the application of the coloring base coating, without an intervening curing.

As the clear coating, for example, an organic solvent-based or water-based thermosetting coating comprising a resin component such as a base resin, crosslinking agent and the like, organic solvent, water, or the like; and where necessary paint additives such as ultraviolet absorber, photostabilizer, curing catalyst, coated surface regulating agent, rheology controlling agent, antioxidant, defoaming agent, wax and the like can be used, which has the transparency to an extent allowing recognition of the under layer coating film visually through the formed clear coating film.

Examples of the base resin include resins containing at least one kind of reactive functional groups such as hydroxyl, carboxyl, silanol, and epoxy groups, such as acrylic, polyester, alkyd, fluorine-containing, urethane, and silicon-containing resins, among which hydroxyl-containing acrylic resins are particularly suitable. Examples of the crosslinking agent include melamine resins, urea resins, (blocked) polyisocyanate compounds, epoxy compounds, carboxyl-containing compounds, acid anhydrides and alkoxysilane-containing compounds, which have reactive functional groups reactable with the functional groups in the base resins, polyisocyanate compounds being particularly preferred.

The clear coating application can be effected on the uncured or cured coloring base coating film, by means of electrostatic coating, to a dry film thickness within a range of normally 10-50 μm, preferably 20-40 μm, if necessary setting the resulting coated film surface at the ambient temperature for around 1-60 minutes or preheating it at a temperature of about 40-about 80° C. for around 1-60 minutes, and thereafter curing it at a temperature of about 60-about 140° C., preferably at about 70-about 120° C., for around 20-40 minutes.

Thus a plastic shaped article is obtained, on whose primer coating film according to the present invention, coloring base coating film and clear coating film are applied.

### EXAMPLES

Hereafter the present invention is explained more specifically, referring to Examples, in which “part” and “%” mean “mass part” and “mass %”, unless otherwise indicated.

### Preparation of Aqueous Dispersions of Modified Polyolefins

### Production Example 1

In a four-necked flask equipped with a stirrer, cooling pipe, thermometer and a dropping funnel, 100 g of a maleic anhydride-grafted polypropylene [a polypropylene obtained with use of metallocene catalyst, which was modified by addition of maleic acid (the amount of addition: 4 mass %), melting point: 80° C., Mw: about 150,000, Mw/Mn: about 2.5] was heat-melted at 140° C., and to which 15 g of polyoxyethylene stearyl ether, NEWCOL1820 (tradename, Nippon Nyukazai Co., one terminal hydroxyl-containing polyoxyethylene compound) was added to carry out their reaction under stirring at 140° C. for 4 hours. After the reaction, the reaction mixture was cooled to 90° C., to which deionized water was added and filtered to provide an aqueous dispersion (A-1) of modified polyolefin having a solid content of 30%.

### Production Example 2

In a four-necked flask equipped with a stirrer, cooling pipe, thermometer and dropping funnel, 200 g of a maleic anhydride-grafted polypropylene [a polypropylene obtained with use of metallocene catalyst, which was modified by addition of maleic acid (the amount of addition: 4 mass %), melting pint: 80° C., Mw: about 150,000, Mw/Mn: about 2.5] was heat-melted at 120° C., to which 10 g of 2-hydroxyacrylate, 0.1 g of a polymerization inhibitor (di-t-butylhydroxytoluene) and 2.0 g of triethylamine were added and stirred for an hour. Further 30 g of polyethylene glycol monomethacrylate (BLENMER PE-350, tradename, NOF Corporation) and 0.3 g of a polymerization initiator (PERBUTYL 0, tradename, NOF Corporation) were added under stirring at 120° C. over an hour to carry out the reaction. After the reaction 4 g of triethylamine was added, followed by 30 minutes' stirring. After cooling the reaction mixture to 90° C., deionized water was added and filtered to provide an aqueous dispersion (A-2) of modified polyolefin having a solid content of 30%.

### Preparation of a Hydroxyl-Containing Acrylic Resin Solution

### Production Example 3

A reactor equipped with a stirrer, reflux condenser and thermometer was charged with 40 parts of propylene glycol monomethyl ether and kept at 120° C. under heating, into which a mixture of 53 parts of cyclohexyl methacrylate, 20 parts of n-butyl acrylate, 21 parts of 2-hydroxyethyl acrylate, 6 parts of acrylic acid and 5 parts of azobisisobutyronitrile was added dropwise over 3 hours, followed by an hour's aging at the same temperature. Then a liquid mixture of 1 part of azobisdimethylvarelonitrile and 10 parts of propylene glycol monomethyl ether was added dropwise over an hour, again followed by further an hour's aging. Adding thereafter 7.4 parts of dimethylethanolamine and 193 parts of deionized water under stirring, a hydroxyl-containing acrylic resin solution (B-1) was obtained. The resultant resin had an acid value of 47 mgKOH/g, a hydroxyl value of 101 mgKOH/g, and a mass-average molecular weight of about 10,000.

### Preparation of Water-Based Primers

### Example 1

Blending 30 parts as the solid mass of the aqueous dispersion (A-1) of modified polyolefin, 70 parts as the solid mass of the hydroxyl-containing acrylic resin solution (B-1), 5 parts of a diester compound (C-1)^{(note 3)}, 20 parts of an electrically conducting pigment (D-1)^{(note 6)} and 80 parts of titanium white^{(note 8)} by the accepted method, and diluting the blend with deionized water to make its solid content 40%, a water-based primer (1) was obtained.

### Examples 2-8 and Comparative Examples 1-5

Through the operations similar to Example 1, water-based primers (2)-(13) were obtained, each having the blending composition varied from that of Example 1 as shown in Table 1.

The blends in Table 1 are shown in terms of the solid contents, and (note 1) to (note 8) in the Table 1 are as follows:

(note 1) aqueous dispersion (A-3) of modified polyolefin: EH-801, tradename, Toyo Kasei Kogyo Co., aqueous dispersion of an acid-modified chlorinated polyolefin, degree of chlorination: 16%, solid content: 30%

(note 2) aqueous urethane resin (B-2): U-COAT UX-310, tradename, Sanyo Chemical Industries, aqueous urethane dispersion

(note 3) diester compound (C-1): a diester compound of polyoxyethylene glycol and n-hexanoic acid; the compound of the general formula (1) wherein both R¹ and R² are pentyl group, R³ is ethylene group and m is 5; molecular weight: 434

(note 4) diester compound (C-2): a diester compound of polyoxyethylene glycol and 2-ethylhexanoic acid; the compound of the general formula (1) wherein both R¹ and R² are 2-ethylpentyl group, R³ is ethylene group, and m is 7; molecular weight: 578

(note 5) diester compound (C-3): a diester compound of polyoxyethylene glycol and 2-ethylhexanoic acid; the compound of the general formula (1) wherein both R¹ and R² are 2-ethylpentyl group, R³ is ethylene group and m is 25; molecular weight: 1,370

(note 6) electrically conducting pigment (D-1): VULCAN XC72, tradename, Cabot Specialty Chemicals Inc., conductive carbon black pigment

(note 7) electrically conducting pigment (D-2): KETJEN EC300J, tradename, Ketjen Black International Co., conductive carbon black pigment

(note 8) electrically conducting pigment (D-3): ET-500W, tradename, Ishihara Sangyo Kaisha, Ltd., conductive titanium oxide

(note 9) titanium white: JR-806, tradename, Tayca Corporation.

TABLE 1

| | | Example | | | | | | | | Comparative Example | | | | |
|---|---|---|---|---|---|---|---|---|---|---|---|---|---|---|
| | | 1 | 2 | 3 | 4 | 5 | 6 | 7 | 8 | 1 | 2 | 3 | 4 | 5 |
| Water-based primer | | (1) | (2) | (3) | (4) | (5) | (6) | (7) | (8) | (9) | (10) | (11) | (12) | (13) |
| Aqueous dispersion | A-1 | 30 | | 30 | | | 30 | 65 | | 30 | 30 | | | |
| of modified polyolefin | A-2 | | 50 | | 50 | | | | 50 | | | 50 | | 50 |
| | A-3 (note 1) | | | | | 60 | 30 | | | | | | 60 | |
| Acrylic resin (B-1) | | 70 | 50 | | | | | 15 | 20 | 70 | 70 | | | |
| Urethane resin (B-2) (note 2) | | | | 70 | 50 | 40 | 40 | 20 | 30 | | | 50 | 40 | 50 |
| Diester compound | C-1 (note 3) | 5 | 10 | | | | | 5 | | | | | | |
| | C-2 (note 4) | | | 5 | 10 | 10 | 10 | | 10 | 30 | | | | |
| | C-3 (note 5) | | | | | | | | | | | | 10 | 10 |
| Electrically | D-1 (note 6) | 20 | 20 | | | 20 | 20 | | | 20 | 20 | | 20 | 20 |
| conducting pigment | D-2 (note 7) | | | 10 | 10 | | | 10 | | | | 10 | | |
| | D-3 (note 8) | | | | | | | | 150 | | | | | |
| Titanium white (note 9) | | 80 | 80 | 80 | 80 | 80 | 80 | 80 | 0 | 80 | 80 | 50 | 80 | 80 |
| Solid content of coating (%) | | 40 | 40 | 40 | 40 | 40 | 40 | 40 | 40 | 40 | 40 | 20 | 40 | 40 |
| Dried film thickness (μm) of water-based primer | | 5 | 5 | 10 | 10 | 5 | 5 | 10 | 10 | 5 | 5 | 5 | 5 | 5 |
| Solid content of transferred coating after 1 minute | | 65 | 65 | 55 | 55 | 65 | 65 | 55 | 65 | 65 | 65 | 30 | 65 | 65 |
| of water-based primer application (%) | | | | | | | | | | | | | | |
| Electrical conductivity of primer | | ⊙ | ⊙ | ⊙ | ⊙ | ⊙ | ⊙ | ⊙ | ◯ | ◯ | ◯ | ⊙ | ⊙ | ⊙ |
| Performance test | finished appearance | ◯ | ◯ | ◯ | ◯ | ◯ | ◯ | ◯ | ◯ | Δ | Δ | X | Δ | Δ |
| result of coated | initial adhesive property | ◯ | ◯ | ◯ | ◯ | ◯ | ◯ | ◯ | ◯ | ◯ | Δ | Δ | ◯ | ◯ |
| test samples 1 | Adhesive property after water | ◯ | ◯ | ◯ | ◯ | ◯ | ◯ | ◯ | ◯ | Δ | X | X | Δ | Δ |
| | resistance test | | | | | | | | | | | | | |
| | Water resistance (appearance) | ◯ | ◯ | ◯ | ◯ | ◯ | ◯ | ◯ | ◯ | X | X | X | X | X |
| Performance test | finished appearance | ◯ | ◯ | ◯ | ◯ | ◯ | ◯ | ◯ | ◯ | X | X | X | X | X |
| result of coated | initial adhesive property | ◯ | ◯ | ◯ | ◯ | ◯ | ◯ | ◯ | ◯ | Δ | X | X | Δ | Δ |
| test samples 2 | Adhesive property after water | ◯ | ◯ | ◯ | ◯ | ◯ | ◯ | ◯ | ◯ | X | X | X | X | Δ |
| | resistance test | | | | | | | | | | | | | |
| | Water resistance (appearance) | ◯ | ◯ | ◯ | ◯ | ◯ | ◯ | ◯ | ◯ | X | X | X | X | X |
| Performance test | finished appearance | ◯ | ◯ | ◯ | ◯ | ◯ | ◯ | ◯ | ◯ | Δ | Δ | X | Δ | Δ |
| result of coated | initial adhesive property | ◯ | ◯ | ◯ | ◯ | ◯ | ◯ | ◯ | ◯ | ◯ | Δ | Δ | ◯ | ◯ |
| test samples 3 | Adhesive property after water | ◯ | ◯ | ◯ | ◯ | ◯ | ◯ | ◯ | ◯ | Δ | X | X | Δ | Δ |
| | resistance test | | | | | | | | | | | | | |
| | Water resistance (appearance) | ◯ | ◯ | ◯ | ◯ | ◯ | ◯ | ◯ | ◯ | X | X | X | X | X |

### Preparation of Coated Test Samples 1

In a coating booth maintained at the ambient temperature of 25° C. and relative humidity of 60%, polypropylene (degreased) which had been shaped into bumpers were air sprayed with the above-prepared water-based primers (1)-(13) each, to the respective dry film thickness as shown in Table 1 and left standing for 90 seconds. Then onto the coated surfaces SOFLEX 415 (tradename, Kansai Paint Co., solvent-based coloring base coat coating) as a coloring base coat coating was electrostatically applied to a dry film thickness of about 15 μm. Successively, as a clear coating SOFLEX 7500 CLEAR (tradename, Kansai Paint Co., acrylic urethane type solvent-based clear coating) was electrostatically applied to a dry film thickness of about 30 μm, followed by drying by heating at 80° C. for 30 minutes, to provide the respective test samples.

### Preparation of Coated Test Samples 2

In a coating booth maintained at the ambient temperature of 25° C. and relative humidity of 60%, polypropylene (degreased) which had been shaped into bumpers were air sprayed with the above-prepared water-based primers (1)-(13) each, to the respective dry film thickness as shown in Table 1 and left standing for 90 seconds. Then onto the coated surfaces RETAN WB ECOBASE (tradename, Kansai Paint Co., water-based coloring base coat coating) as a coloring base coat coating was electrostatically applied to a dry film thickness of about 15 μm, and preheated at 80° C. for 3 minutes. Successively, as a clear coating, SOFLEX 7500 CLEAR (tradename, Kansai Paint Co., acrylic urethane type solvent-based clear coating) was electrostatically applied to a dry film thickness of about 30 μm, followed by drying by heating at 80° C. for 30 minutes, to provide the respective test samples.

### Preparation of Coated Test Samples 3

In a coating booth maintained at the ambient temperature of 25° C. and relative humidity of 60%, polypropylene (degreased) which had been shaped into bumpers were air sprayed with the above-prepared water-based primers (1)-(13) each, to the respective dry film thickness as shown in Table 1 and left standing for 90 seconds. Then onto the coated surfaces SOFLEX 415 (White) (tradename, Kansai Paint Co., solvent-based coloring base coat coating) as a coloring base coat coating was electrostatically applied to a dry film thickness of about 15 μm. Successively, as a pearlescent base coat coating, SOFLEX 415 (Pearlescent) (tradename, Kansai Paint Co., solvent-based coloring base coat coating) was electrostatically applied to a dry film thickness of about 10 μm. Further as a clear coating, SOFLEX 7500 CLEAR (tradename, Kansai Paint Co., acrylic urethane type solvent-based clear coating) was electrostatically applied to a dry film thickness of about 30 μm, followed by drying by heating at 80° C. for 30 minutes, to provide the respective test samples.

The solid content of the transferred coating after 1 minute of the water-based primer application was determined as follows: first, apply a coating onto a fixed area of aluminum foil under the same conditions as described above, recover the foil after 1 minute of the application, immediately fold in the aluminum foil to prevent any further evaporation of water from the coated film and quickly measure its weight. Then open up the aluminum foil, cure the coated film thereon under the same conditions to those of heat-curing the multilayered coating film, measure the weight after the curing, and calculate the solid content of the transferred coating from these weights and the advancedly measured weight of the aluminum foil itself.

### Performance Tests

Those coated test samples prepared as above were subjected to the following performance tests, with the results as given concurrently in Table 1.

(*1) Electrical conductivity of primer: The water-based primers (1)-(13) were each spray coated on a polypropylene plate (degreased) to a dry film thickness of about 15 μm. Thus formed primer coating films were heated at 80° C. for 5 minutes, and the surface resistivity (Ω/□) of each of the coating film was measured with MODEL 150 (tradename, TREK Inc.) at 20° C. The results are shown according to the following standard.

\textcircled{}: less than 1 MΩ

◯: from 1 MΩ to less than 100 MΩ

Δ: from 100 MΩ to less than 10,000 MΩ

x: 10,000 MΩ or higher.

(*2) Finished appearance: The finished appearance of each of the coated films after application of the top coating was visually evaluated according to the following standard:

◯: both finished texture and luster were good

Δ: finished texture or luster was less satisfactory

x: both finished texture and luster were unsatisfactory.

(*3) Initial adhesive property: The coated surface of each test coated samples was crosscut with a cutter to the depth-reaching the substrate, to draw one-hundred 2 mm×2 mm squares. An Adhesive Cellophane Tape™ was stuck on the surface and rapidly peeled off at 20° C. The number of squares which remained on the coated surface was counted and indicated according to the following standard.

◯: 100 squares (no peeling off)

Δ: 99-50 squares

x: no more than 49 squares.

(*4) Water resistance and adhesive property after water resistance test: A part of each of the coated bumpers as the test samples was cut off, dipped in 40° C. warm water for 10 days, withdrawn, dried and given an adhesion test similar to the above initial adhesive property test. The number of remaining coated film squares was counted and evaluated similarly to the above, (adhesive films were observed whether blisters were formed. The results are indicated according to the following standard (water resistance):

◯: no blister occurred

x: blisters occurred.

1. A water-based primer composition characterized in that it comprises
(A) an aqueous dispersion of modified polyolefin,
(B) an aqueous urethane resin and/or aqueous acrylic resin,
(C) a diester compound of the general formula (1) 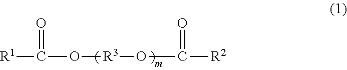
[in the formula, R¹ and R² each independently stands for C₄₋₁₈ hydrocarbon group, R³ stands for C₂₋₄ alkylene group, m is an integer of 3-20, and mR³s may be the same or different] and
(D) an electrically conducting pigment,
the content of the diester compound (C) being within a range of 1-15 mass parts to 100 mass parts of the total solid content of the component (A) and the component (B).

2. A water-based primer composition according to claim 1, in which the aqueous dispersion (A) of modified polyolefin is one in which an unsaturated carboxylic acid- or acid anhydride-modified polyolefin (i) is dispersed in an aqueous medium.

3. A water-based primer composition according to claim 1, in which the aqueous dispersion (A) of modified polyolefin is one in which a modified polyolefin formed by further modifying the unsaturated carboxylic acid- or acid anhydride-modified polyolefin (i) with a polyoxyalkylene chain-containing compound is dispersed in an aqueous medium.

4. A water-based primer composition according to claim 2, in which the unsaturated carboxylic acid- or acid anhydride-modified polyolefin (i) is a polyolefin modified with maleic acid or acid anhydride thereof.

5. A water-based primer composition according to claim 2, in which the unsaturated carboxylic acid- or acid anhydride-modified polyolefin (i) has a melting point within a range of 50-100° C.

6. A water-based primer composition according to claim 2, in which the unsaturated carboxylic acid- or acid anhydride-modified polyolefin (i) has a mass-average molecular weight within a range of 30,000-180,000.

7. A water-based primer composition according to claim 2, in which the unsaturated carboxylic acid- or acid anhydride-modified polyolefin (i) has a mass-average molecular weight (Mw)/number-average molecular weight (Mn) ratio within a range of 1.5-4.0.

8. A water-based primer composition according to claim 1, in which the aqueous urethane resin (B-1) is a urethane dispersion.

9. A water-based primer composition according to claim 1, in which the aqueous acrylic resin (B-2) has a hydroxyl value of 20-200 mgKOH/g and an acid value of 1-100 mgKOH/g.

10. A water-based primer composition according to claim 1, in which the component (A)/component (B), in terms of solid mass ratio, is within a range of 10/90-70/30.

11. A water-based primer composition according to claim 1, in which the diester compound (C) is a compound of the formula (1) wherein R¹ and R² stand for C₆₋₈ alkyl group independently of each other, R³ stands for ethylene group, and m is an integer of 4-10.

12. A water-based primer composition according to claim 1, in which the electrically conducting pigment (D) is a conductive carbon.

13. A coating method characterized by comprising applying a water-based primer composition as described in claim 1 onto a plastic substrate, and then applying a top coating onto the coated surface.

14. A method according to claim 13, in which a coloring base coating and clear coating are successively applied as the top coating.

15. Articles coated by the method as described in claim 13.

16. A water-based primer composition according to claim 3, in which the unsaturated carboxylic acid- or acid anhydride-modified polyolefin (i) is a polyolefin modified with maleic acid or acid anhydride thereof.

17. A water-based primer composition according to claim 3, in which the unsaturated carboxylic acid- or acid anhydride-modified polyolefin (i) has a melting point within a range of 50-100° C.

18. A water-based primer composition according to claim 3, in which the unsaturated carboxylic acid- or acid anhydride-modified polyolefin (i) has a mass-average molecular weight within a range of 30,000-180,000.

19. A water-based primer composition according to claim 3, in which the unsaturated carboxylic acid- or acid anhydride-modified polyolefin (i) has a mass-average molecular weight (Mw)/number-average molecular weight (Mn) ratio within a range of 1.5-4.0.

20. Articles coated by the method as described in claim 14.
